(19) United States
(12) Patent Application Publication
(10) Pub. No.: US 2016/0080278 A1
(43) Pub. Date: Mar. 17, 2016

(54) LOW PROFILE APPROXIMATIVE RATE LIMITER

(71) Applicant: Alcatel-Lucent Canada, Inc., Ottawa (CA)

(72) Inventors: Guangnian Wu, Kanata (CA); Pawel S. Raubic, Nepean (CA)

(73) Assignee: Alcatel-Lucent Canada, Inc.

(21) Appl. No.: 14/483,850

(22) Filed: Sep. 11, 2014

(51) Int. Cl. H04L 12/841; H04L 12/835; H04L 12/26

(52) U.S. Cl. CPC H04L 47/28; H04L 43/0882; H04L 43/106; H04L 47/30

(57) ABSTRACT

Various exemplary embodiments relate to a method for detecting that messages are incoming to a networked device above a target rate, the method including recording a timestamp for at least three representative samples of messages arriving at the networked device; calculating the duration of a focus group including one or more of the representative samples, wherein the target rate is a number r messages over a number m seconds and the focus group represents r/2 messages; and determining the duration of the focus group is less than m seconds.

### TECHNICAL FIELD

Various exemplary embodiments disclosed herein relate generally to rate limiting used to control the rate of traffic sent or received by a network communications device.

### BACKGROUND

Rate limiting is used to control the rate of traffic sent or received by a network communications device, typically a network node, client, or server. Rate limiting is necessary because each device is capable of processing only a limited amount of network traffic at any one time. If traffic to and from a device is not controlled, there is a risk that communications bursts may fill the device to capacity or overfill the device, which may result in network congestion and poor performance of the network as traffic is dropped and/or re-transmitted.

### SUMMARY

In light of the present need for efficient use of network device resources, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a non-transitory machine-readable storage medium encoded with instructions for execution by a networked device for detecting that messages are incoming to the networked device above a target rate, the non-transitory machine-readable storage medium including instructions for recording a timestamp for at least three representative samples of messages arriving at the networked device; instructions for calculating the duration of a focus group including one or more of the representative samples, wherein the target rate is a number r messages over a number m seconds and the focus group represents r/2 messages; and instructions for determining the duration of the focus group is less than m seconds. In alternative embodiments each representative sample of messages is the same size.

Some embodiments include instructions for determining the target rate; instructions for determining an accuracy; and instructions for calculating a number of iterations i based on the accuracy. Alternative embodiments include instructions for calculating a partition size based on the accuracy and the target rate, wherein a size each of the representative sample of messages is the partition size. In some embodiments, the partition size represents 1 message for every r/2i messages received by the device. In some embodiments, the accuracy is 1−(0.05)i wherein i is the number of iterations.

Alternative embodiments further include instructions for determining a buffer size. In some alternative embodiments, the buffer size is 3/2*2i multiplied by the size of a timestamp in memory. Some embodiments further include instructions for calculating the duration of a prior group including one or more of the representative samples, wherein the prior group represents r/2 messages received by the device immediately prior to the focus group; and instructions for determining the duration of the focus group and the prior group is less than m seconds. Some alternative embodiments further include instructions for determining an adjusted target rate of a number r/2 messages over a number m′ seconds where m′ is m seconds minus the duration of the focus group; instructions for determining a following group including one or more of the representative samples, wherein the following group represents the r/2 messages received by the device immediately after the focus group; and instructions for dividing the prior group and the following group into four groups, a first group, a second group, a third group, and a fourth group, wherein each of the first and second groups represents r/4 messages including the r/2 messages including the prior group and each of the third and fourth groups represents r/4 messages including the r/2 messages including the following group.

Some embodiments further include instructions for creating a first branch including the first group, the second group, and the third group; and instructions for creating a second branch including the second group, the third group, and the fourth group. Some embodiments further include instructions for determining the duration of the second group is less than m′; instructions for determining the duration of the first group; and instructions for determining the duration of the third group.

Alternative embodiments of the non-transitory machine-readable storage medium further include instructions for calculating the duration of a following group including one or more of the representative samples, wherein the following group represents r/2 messages received by the device immediately after the focus group; and instructions for determining the duration of the focus group and the following group is less than m seconds. Some embodiments further include instructions for determining if there are not enough representative samples to create a following group representing r/2 messages, delaying the step of determining the duration of the focus group and the following group until enough representative samples have been collected to create a following group representing r/2 messages. Some alternative embodiments further include instructions for determining if the focus group includes more than one representative sample.

Various exemplary embodiments relate to a non-transitory machine-readable storage medium encoded with instructions for execution by a networked device for detecting that messages are incoming to the networked device above a target rate, the non-transitory machine-readable storage medium including instructions for determining the target rate of a number r messages over a number m seconds; instructions for determining an accuracy; instructions for calculating a number of iterations i based on the accuracy; instructions for recording a timestamp for at least three representative samples of messages arriving at the networked device; instructions for calculating the duration of a focus group including one or more of the representative samples, wherein the focus group represents r/2 messages; instructions for determining the duration of the focus group is less than m seconds; instructions for calculating the duration of a prior group including one or more of the representative samples, wherein the prior group represents r/2 messages received by the device immediately prior to the focus group; instructions for calculating the duration of a following group including one or more of the representative samples, wherein the following group represents the r/2 messages received by the device immediately after the focus group; instructions for determining the duration of the focus group and at least one of the prior group and the following group is less than m; instructions for determining an adjusted target rate of the number of messages in the focus group over a number of seconds m′, wherein m′ is m minus the duration of the focus group; instructions for dividing the prior group and the following group into four groups, a first group, a second group, a third group, and a fourth group, wherein each of the first and second groups represents r/4 messages including the r/2 messages including the prior group and each of the third and fourth groups represents r/4 messages including the r/2 messages including the prior group; instructions for creating a first branch including the first group, the second group, and the third group; and instructions for creating a second branch including the second group, the third group, and the fourth group.

Alternative embodiments further include instructions for determining if the focus group includes more than one representative sample; and until the focus group does not include more than one representative sample, or determining the duration of the focus group and each of the prior group and the following group is greater than or equal to the adjusted rate, repeating the steps of: calculating the duration of a focus group, determining the duration of the focus group, calculating the duration of a prior group, calculating the duration of a following group, determining the duration of the focus group and at least one of the prior group and the following group, determining an adjusted target rate, dividing the prior group and the following group into four groups, creating a first branch, and creating a second branch.

Various exemplary embodiments relate to a method for detecting that messages are incoming to a networked device above a target rate, the method including recording a timestamp for at least three representative samples of messages arriving at the networked device; calculating the duration of a focus group including one or more of the representative samples, wherein the target rate is a number r messages over a number m seconds and the focus group represents r/2 messages; and determining the duration of the focus group is less than m seconds. In alternative embodiments each representative sample of messages is the same size.

Some embodiments include determining the target rate; determining an accuracy; and calculating a number of iterations i based on the accuracy. Alternative embodiments include calculating a partition size based on the accuracy and the target rate, wherein a size each of the representative sample of messages is the partition size. In some embodiments, the partition size represents 1 message for every r/2i messages received by the device. In some embodiments, the accuracy is 1−(0.05)i wherein i is the number of iterations.

Alternative embodiments further include determining a buffer size. In some alternative embodiments, the buffer size is 3/2*2i multiplied by the size of a timestamp in memory. Some embodiments further include calculating the duration of a prior group including one or more of the representative samples, wherein the prior group represents r/2 messages received by the device immediately prior to the focus group; and determining the duration of the focus group and the prior group is less than m seconds. Some alternative embodiments further include determining an adjusted target rate of a number r/2 messages over a number m′ seconds where m′ is m seconds minus the duration of the focus group; determining a following group including one or more of the representative samples, wherein the following group represents the r/2 messages received by the device immediately after the focus group; and dividing the prior group and the following group into four groups, a first group, a second group, a third group, and a fourth group, wherein each of the first and second groups represents r/4 messages including the r/2 messages including the prior group and each of the third and fourth groups represents r/4 messages including the r/2 messages including the prior group.

Some embodiments further include creating a first branch including the first group, the second group, and the third group; and creating a second branch including the second group, the third group, and the fourth group. Some embodiments further include creating a first branch including the first group, the second group, and the third group; and creating a second branch including the second group, the third group, and the fourth group. Some embodiments further include determining the duration of the second group is less than m′; determining the duration of the first group; and determining the duration of the third group.

Alternative embodiments of the method further include calculating the duration of a following group including one or more of the representative samples, wherein the following group represents r/2 messages received by the device immediately after the focus group; and determining the duration of the focus group and the following group is less than m seconds. Some embodiments further include determining if there are not enough representative samples to create a following group representing r/2 messages, delaying the step of determining the duration of the focus group and the following group until enough representative samples have been collected to create a following group representing r/2 messages. Some alternative embodiments further include determining if the focus group includes more than one representative sample.

Various exemplary embodiments relate to a method for detecting that messages are incoming to a networked device above a target rate, the method including determining the target rate of a number r messages over a number m seconds; determining an accuracy; calculating a number of iterations i based on the accuracy; recording a timestamp for at least three representative samples of messages arriving at the networked device; calculating the duration of a focus group including one or more of the representative samples, wherein the focus group represents r/2 messages; determining the duration of the focus group is less than m seconds; calculating the duration of a prior group including one or more of the representative samples, wherein the prior group represents r/2 messages received by the device immediately prior to the focus group; calculating the duration of a following group including one or more of the representative samples, wherein the following group represents the r/2 messages received by the device immediately after the focus group; determining the duration of the focus group and at least one of the prior group and the following group is less than m; determining an adjusted target rate of the number of messages in the focus group over a number of seconds m′, wherein m′ is m minus the duration of the focus group; dividing the prior group and the following group into four groups, a first group, a second group, a third group, and a fourth group, wherein each of the first and second groups represents r/4 messages including the r/2 messages including the prior group and each of the third and fourth groups represents r/4 messages including the r/2 messages including the following group; creating a first branch including the first group, the second group, and the third group; and creating a second branch including the second group, the third group, and the fourth group.

Alternative embodiments further include determining if the focus group includes more than one representative sample; and until the focus group does not include more than one representative sample, or determining the duration of the focus group and each of the prior group and the following group is greater than or equal to the adjusted rate, repeating the steps of: calculating the duration of a focus group, determining the duration of the focus group, calculating the duration of a prior group, calculating the duration of a following group, determining the duration of the focus group and at least one of the prior group and the following group, determining an adjusted target rate, dividing the prior group and the following group into four groups, creating a first branch, and creating a second branch.

Various exemplary embodiments relate to networked device, the device including a network interface; and a processor in communication with the network interface, the processor being configured to receive, via the network interface, messages; record a timestamp for at least three representative samples of messages; calculate the duration of a focus group comprising one or more of the representative samples, wherein a target rate is a number r messages over a number m seconds and the focus group represents r/2 messages; and determine the duration of the focus group is less than m seconds. In alternative embodiments of the device, the processor is further configured to determine the target rate; determine an accuracy; calculate a number of iterations i based on the accuracy; calculate a partition size based on the accuracy and the target rate, wherein a size each of the representative sample of messages is the partition size, wherein the partition size represents 1 message for every r/2i messages received by the device; calculate the duration of a prior group comprising one or more of the representative samples, wherein the prior group represents r/2 messages received by the device immediately prior to the focus group; and determine the duration of the focus group and the prior group is less than m seconds.

It should be apparent that, in this manner, various exemplary embodiments enable efficient use of network device resources. In particular, by maximizing the amount of resources that can be allocated to traffic processing by the device and other core processes.

### BRIEF DESCRIPTION OF THE DRAWINGS

In order to better understand various exemplary embodiments, reference is made to the accompanying drawings, wherein:

FIG. 1 illustrates an exemplary sliding window scheme for monitoring the rate of traffic in a network device;

FIG. 2 illustrates an exemplary generic timeline partition for detecting a potential breach of a target rate limit;

FIG. 3 illustrates an exemplary grouping of messages for which a breach of a target rate limit may be detected;

FIG. 4 illustrates an exemplary depiction of a method for detecting a potential breach of a target rate limit;

FIG. 5 illustrates an exemplary hardware diagram for a device in which communications traffic may be rate limited.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein. Further, while various exemplary embodiments are described with regard to rate limiting in network devices, it will be understood that the techniques and arrangements described herein may be implemented to facilitate rate threshold breaches in other types of systems that implement multiple types of data processing or data structure.

One factor in the amount of traffic a network device is capable of handling is the resources it has available for traffic processing. Hardware and other resources of a network device may be limited by installed capacity or other factors such as heat dissipation, ventilation, electricity, and/or physical space/size limitations. Not all of the hardware resources of a device may be devoted to processing traffic; some must be devoted to administrative tasks and other non-core activities.

In a device embedded in a real-time system where an incoming data rate must be kept below a certain threshold to prevent filling or overloading the device, and if the inbound data rate is above such a predefined threshold, the system must be notified so that appropriate steps may be taken to divert or limit the rate of incoming data or to take other appropriate action. Because by definition such a device must respond in real time, and thus the time to adjust to changing data rates may be extremely limited, a proper implementation of a rate limiting mechanism must be able to deal with a large volume of information efficiently both in terms of storage space and processing time—if a large volume of information is incoming to the device, processing resources must be devoted to handling the data burst at the same time that the device must determine the best way to identify and handle a potential overload situation.

Previously known solutions for monitoring potential data overruns use a sliding window scheme to monitor the status of the rate of incoming data in comparison to known target data rates. See, e.g. IETF RFC (Request for Comments) 2859 “A Time Sliding Window Three Colour Marker”, last accessed Jul. 20, 2014 at http://tools.ietf.org/html/rfc2859. However, the traditional method of using a sliding window consumes a great deal of processing and memory resources because every incoming message must be stored, time-stamped, and saved in memory, and the window is moved by locating and measuring the number of messages in between the ends of the sliding window. For example, for an exemplary target rate of 1 million messages per second, 1 million timestamps must be kept in memory for the most recent 1 million messages. The first timestamp may be checked against the most current timestamp to determine if the difference is less than the target 1 second. Thus, the traditional sliding window will consume enough memory for at least the number of timestamps for a number of messages equal to the target rate.

In view of the foregoing, it would be desirable to increase the efficiency of the use of any of the resources of a network device in order to maximize the amount of resources that can be allocated to traffic processing by the device and other core processes. In particular, it would be desirable to minimize the use of resources by non-core activities.

Referring now to the drawings, in which like numerals refer to like components or steps, there are disclosed broad aspects of various exemplary embodiments.

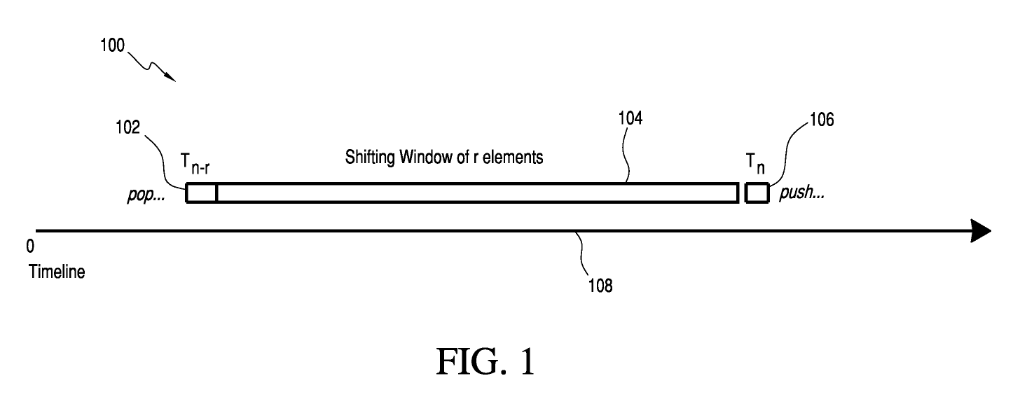

FIG. 1 illustrates an exemplary sliding window scheme 100 for monitoring the rate of traffic in a network device. In this arrangement, the device for which the traffic rate monitored may have a target rate of r units for m seconds, or Tᵣₐₜₑ=r(units)/m(seconds). The window 104 shifts through a timeline 108 by removing or popping older messages 102 from the window 104 and adding or pushing newer messages 106 to the window, where each incoming message may be given a sequential index number n, and where for every message where n is greater than or equal to the earliest index 0 and less than r (0=<n<r), the message is pushed onto the window at Tₙ 106, and where for every message in the window 104 where n is greater than or equal to r (n>=r), the message is removed 102 from the window 104 at Tₙ₋ᵣ. The threshold will be determined to have been breached if the timestamp of the highest index included in the window Tₙ minus the timestamp of the lowest index included in the window Tₙ₋ᵣ is less than m seconds (Tₙ−Tₙ₋ᵣ<m)—because a target rate messages will have arrived at the device in less than m seconds, it will be assumed that at least one additional message will have arrived at the device before m seconds has elapsed, and therefore that a breach has occurred.

In terms of processing power, the sliding window solution may be considered relatively efficient because it performs only one subtraction and two queue operations per element, achieving O(n) processing time. However, a buffer of size r multiplied by the size of a timestamp (Storage=r*size_{date}) would have to be maintained at all times, and there are many message elements n that must be processed for each addition and subtraction or push 106 and pop 102 of the sliding window 104. When the target rate r is small, this may not be a problem, but when the target rate r selected by a user or administrator is high (for example, r=1 million), memory usage requirements may make this solution overly costly or even infeasible to implement.

In order to increase the efficiency of rate monitoring so as to minimize the processing power required, rather than linearly partitioning incoming messages using a sliding window, e.g., slices of time as represented my incoming messages, the target number of messages may instead be partitioned non-linearly into binary trees of representative messages. Representative messages may be taken at a sample rate, for example, 1 message for every 1000 incoming messages, where the timestamp for the partition will be the timestamp of the final sampled message in the group. Thus, much less memory will be consumed to store the representative partitions than for a sliding window.

The partitions may be iteratively scanned to detect a breach as described below. Because in certain conditions a breach may be detected on only a portion of the target messages, less memory and processing power will be required to detect a breach than using a brute force approach as in a sliding window which captures every message.

However, because only a representative sample of the incoming messages will be processed, the detection rate will be probabilistic—a “miss” may happen when a breach goes undetected. It is impossible to detect a breach where none occurred, so a false positive will not cause a miss. Misses can occur where the target rate is exceeded but because the binary partitions are sampled, an edge condition occurs where the rate is close to the target rate for a brief period, but the sample is taken when there is a non-uniform dip in incoming messages. It may be assumed that misses will be uniformly distributed, which may be the case in a uniform network. Misses may be acceptable because scanning occurs frequently, so even when a breach initially goes undetected, it is possible to detect the breach in the next interval and it is extremely unlikely that the breach will go undetected multiple times in a row.

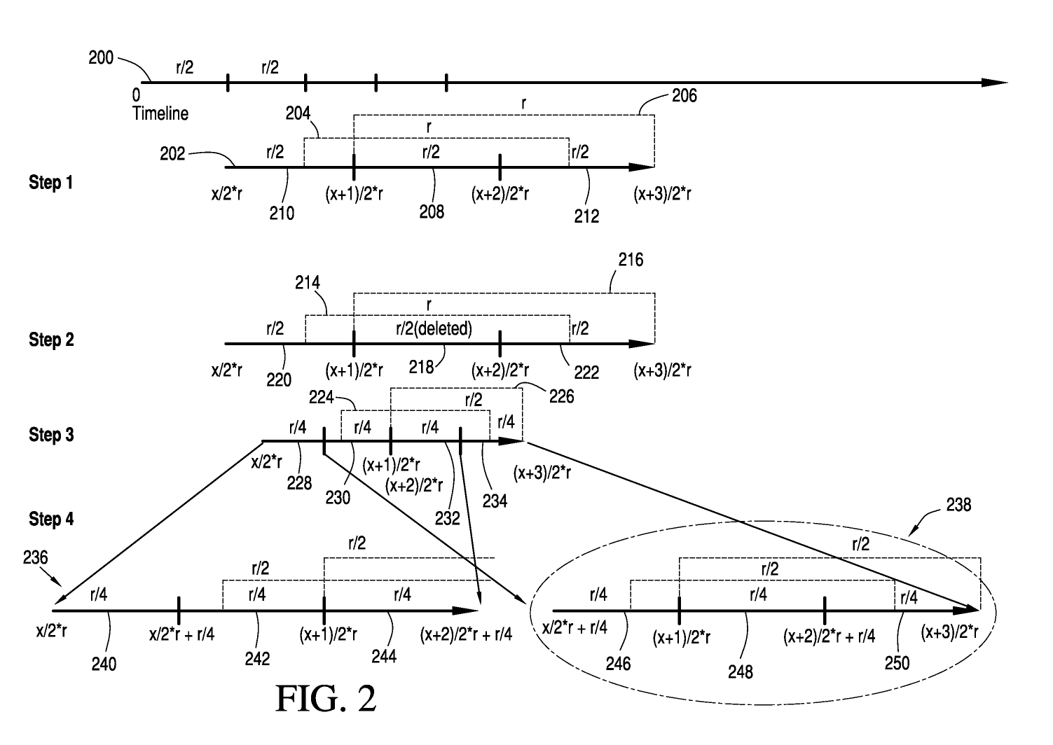

FIG. 2 illustrates an exemplary timeline partition 200 for detecting a potential breach. As noted above, messages may be sampled and divided into partitions. The partitions in timeline 200 may each be the same size, where the partition size may be determined in relation with the target rate and the desired accuracy rate. Prior to choosing a partition size, an accuracy of the rate limiter may be decided, which is determined as 1−(0.05)ⁱ where i is a number of iterations, and a buffer in memory may be created to hold at least 3/2*2ⁱ time stamps. A typical accuracy rate of 93.75% may require four iterations as discussed herein.

As may be seen in Step 1, the incoming messages may be scanned in real time, and a focus group 208 of n partitions may be checked at a time such that the focus group may have r/2 elements; timeline 202 (corresponding to timeline 200) is initially broken into r/2 slices of time, where any two 204, 206 of a group of partitions x/2*r, (x+1)/2*r, (x+2)/2*r, (x+3)/2*r are half of the messages of rate r(units). For every r/2ⁱ elements a message timestamp may be sampled upon message receipt and the time difference from the previous period may be recorded to be pushed to the head of the buffer. The timestamp recorded for the representative message will be representative of all of the messages in that period; new messages following the latest representative message will not have a representative timestamp until the end of the next period when a new timestamp is taken. As may be seen below, every 2ⁱ⁻¹ periods will be checked, a size half of the target rate of r.

The time elapsed may be calculated for a focus group of partitions (x+1)/2*r 208 to determine if they exceed the target rate. It may be understood that a group of partitions such as the focus group 208 will exceed the target rate if the time elapsed for the group is shorter than the target amount of time. For example, if the target rate derived from the time elapsed for the period the current group under analysis spent aggregating, or Group Period <m, then it is possible the current group exceeds the target rate of r elements. If no potential breach is found while scanning a block of partitions of size r/2, the last partition in the group may be dropped and the next partition added to the group for scanning, and so on until a potential breach is detected. It may be assumed for purposes of the calculation that r messages are grouped uniformly; thus if the r/2 group falls under the time constraint of r/m, a potential threshold breach has been found.

However, because in reality the distribution of messages is not uniform and very brief but manageable bursts of messages may occur, if such a potential brief is found, when a potential breach is found for a partition spanning r/2, additional scanning must take place to determine if a breach in fact did occur. Accuracy may be further improved by looking at the two groups of r/2 messages just prior to 210 and just following 212 the focus group 208, in both cases determining the rate of these groups to determine if a breach occurred. Note that if a potential breach is detected for a group of r/2 partitions but not enough messages have entered the buffer to constitute a following group 212 of size r/2, then message scanning/collection may continue and further detection of a threshold breach be delayed until there are sufficient messages to make up group 212 so that the evaluation of the focus group 208 may continue. (Note that there will always be enough messages in the buffer to constitute a focus group 208 and prior group 210, otherwise no detection is possible). If the buffer is filled enough to evaluate focus group 208 with respect to one of the partner groups 210 or 212 but the partner group 210 or 212 in combination with the focus group 208 does not exceed the target rate, the current scan may be terminated without reaching a positive determination of a breach. However, if the size of the focus group 208 in the iterative process (see below) is equal to only one partition, it will by definition be indivisible, and it may be positively determined that the threshold has been breached.

For example, if the target rate is r/m and the time elapsed for the r/2 messages in the focus group is m′, the r/2 messages in each of the prior group 210 and the following group 212 may be scanned to determine if the time elapsed is less than the remaining time from m, m−m′=m″—in other words, to avoid a breach the target rate for a group of size r/2 just before 210 or just after 212 the focus group 208 may be (r/2)/m″. Put yet another way, a breach has occurred if the time taken by a combination of two groups, either 208 and 210 or 208 and 212, include a group of representative message partitions that were received over a period m^{x} less than m, m^{x}=T₍ₓ₊₂₎/2*r−T₍ₓ₊₁₎/2*r (where T is the time taken by each partition). If the rate for each of the group of messages just prior to 210 and just following 212 the focus group 208 is less than (r/2)/m″ such that T₍ₓ₊₂₎/2*r−T₍ₓ₊₁₎/2*r>=m, then it may be determined that a breach has not occurred. If the target rates exceed (r/2)/m″ then the scan may continue to Steps 2 and 3 as follows to evaluate the potential breach. Note that Steps 2 through 4 will only take place if the groups are divisible as discussed herein.

The purpose of Steps 2 through 4 may be to iteratively apply Step 1 in a recursive manner, so that in an ideal case only a portion of the buffer may be scanned in any iteration. In Step 2, the focus group 218 (corresponding to focus group 208) where a potential threshold breach was detected, and the prior and following groups 220, 222 (corresponding to groups 210, 212) will have a total of 3n partitions with 3r/2 elements. The target rate 214, 216 may be adjusted in Step 2 because it may be assumed from the scan that the middle group 218 is part of the overflowing series, and thus the periods around it may be analyzed to determine if they exceed an adjusted target rate of (r/2)/m″. In Step 3 the focus group is disregarded and thus removed from the buffer, leaving two groups containing 2ⁱ⁻¹ periods. The new target rate 224, 226 for each of the two groups 220, 222 may be considered to be (r/2)/m″. Thus, the remaining two groups may be divided into four groups 228, 230, 232, 234 of size r/4, each containing 2ⁱ⁻² periods. Group 228 may begin at time x/2*r and end at x/2*r+r/4, group 230 may begin at x/2*r+r/4 and end at (x+1)/2*r, group 232 may begin at (x+2)/2*r and end at (x+2)/2*r+r/4, and group 234 may begin at (x+2)/2*r+r/4 and end at (x+3)/2*r.

At Step 4 the four groups 228, 230, 232, and 234 in the buffer may be reorganized and divided into two branch formations 236, 238 of 3 r/4 groups each where the first group includes the first three r/4 elements (228, 230, 232) and the second group has the last three r/4 elements (230, 232, 234). Thus, elements 210 and 220 may correspond to each other, elements 228 and 230 together may correspond to element 220 and to elements 240, 242, respectively, and element 242 may correspond to element 246. Likewise, elements 212 and 222 may correspond to each other, elements 232 and 234 together may correspond to element 222 and to elements 248, 250, respectively, and element 244 may correspond to element 248. Note that because each group 240-250 is half the size of the previous groups, the total buffer size may stay the same at 3/2*2ⁱ periods despite the increase in the number of groups tracked in each iteration.

The Step 1 scan described above may be repeated iteratively on each branch 236, 238 with a focus 242 and 248, prior 240 and 246, and following group 244 and 250 in the first branch 236 and second branch 238, steps 2 through 4 repeating with each branch further deleting the focus group (Step 2) and branching with the prior and following groups (Steps 2 and 4) until each group is no longer divisible, i.e. each group is a single partition. In the example shown in FIG. 2, if no group is found in branch 236 where the period elapsed exceeds the target rate (r/2)/m″, the branch may be abandoned. Because of the possibility of a miss, it is generally not considered that abandoning a branch indicates that a breach has not occurred, merely that no confirmable breach has been detected for that branch. As shown in the example of FIG. 2, the time taken by group 248 of size r/4 may be less than that dictated by the target rate (r/2)/m″, so in the example a potential breach may be positively identified.

Note that partitions will be sized based on the target rate and the desired accuracy in detecting a breach, which is tied to the number of iterations as discussed below. If i iterations are desired, then there must be at least 3/2*2ⁱ partitions for the first iteration 202. The accuracy of such an iterative scan will be 1−(0.5)ⁱ where i is the number of iterations. For example, four iterations of a binary tree may achieve 93.75% accuracy. The complexity of the process (which effects the processing time) will be O(i2ⁱ), and the memory usage will be less than or equal to 3/2*2ⁱ. This is significantly less than the memory usage relative to O(r) when a sliding window is used to detect a breach and when r is a large number. Note that when the timeline is partitioned as discussed, the memory usage is dependent solely on the accuracy, which is effected by the number of process iterations, which in turn is independent of the threshold rate.

Thus, the binary partition method of rate detection will scale to large numbers of incoming messages much better than a method using a sliding window. If four iterations are used as described above, over 90% accuracy may be achieved. Note that additional iterations may not be deemed worthwhile in relation to the additional processing power and memory usage—three iterations will yield 87.5% accuracy in at most O(24) complexity (“at most” since some branches may be abandoned), four iterations will yield 93.75% accuracy at a complexity of at most O(64), but five will yield 96.875% accuracy (a gain of only 3.125%) and use twice as much memory at a complexity of at most O(160), and six iterations will yield 98.4% accuracy (a gain of only 1.563%) and use again twice as much memory at a complexity of at most O(384). The process is even better in terms of memory consumption because the messages are sampled and only consume additional memory resources is a potential threshold is detected, as opposed to the brute force approach where a timestamp for every message in the target amount must be maintained in memory. Thus, arithmetically processing three groups of time periods as described above with excellent accuracy may take O(i2ⁱ) processing time and use 3/2*2ⁱ timestamps worth of memory, with four iterations preferred for many cases.

Thus, scanning and detection may be carried out using a heuristic algorithm where the possibility of a threshold breach may be narrowed to near certainty, often in less time and using less resources than determining a breach using a sliding window in a brute force approach. However, note that there may be a small and variable delay in processing when a potential threshold is detected but when there is no corresponding breach in a prior group, as a third (following) group may have to be collected before threshold detection can commence. In certain real-time scenarios where processing power and memory are less important than immediate results, a real-time but brute-force and resource-intensive approach may be preferable.

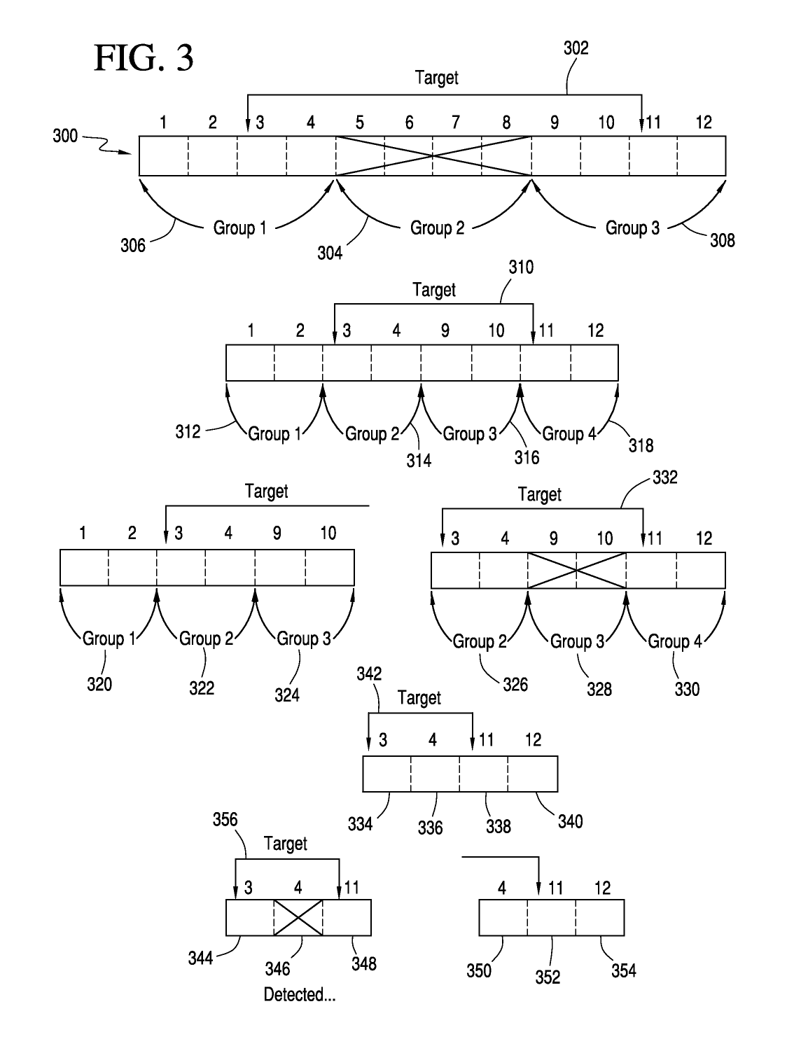

FIG. 3 illustrates an exemplary grouping of messages 300 for which a breach may be detected over three iterations. Grouping 300 includes 12 exemplary partitions 1-12. The target 302 of r(units)/m(seconds) spans eight partitions and may be breached over the span Groups 1-3, including all of Group 2 304 and portions of Groups 1 and 3 (306 and 308). Grouping 300 includes a focus group 302, a prior group 304, and a following group 308, each of r/2 units over m seconds—the target of size r has eight partitions, so for the first iteration the scan will analyze four partitions (r/2). As already noted, the size of a partition may depend upon the number of iterations, which may be determined by the desired accuracy. In this instance, with an accuracy of 93.75% four iterations are required, and the target spans 8 partitions, so each partition will represent r/8 message timestamps. For example, if the target rate was (8000 messages)/(1 second), each partition such as 1-12 may represent a period of time in which 1000 messages was received. Note that because the partitions are representative samples, in real terms a target 302 may span a portion of the partitions as seen with partitions 3 and 11 of grouping 300.

Because the partitions may be analyzed as a binary tree, the number of partitions necessary to analyze the target rate will be dependent on the accuracy the user wants to achieve, and the number of partitions will be 3/2*(1/(1−Accuracy)), where m is the desired accuracy. As noted above, the accuracy of the scan is dependent on the number of iterations, or 1−(0.5)ⁱ; where an accuracy of 87.5% is desired, three iterations may be required to determine if there is a breach, (3/2*(1/(1−0.875))=12). If an accuracy of 93.75% were desired, four iterations would be required to determine if there were a breach, and 24 partitions in three groups of eight partitions each. So, in the example set 300, exemplary partitions 1-12 may be grouped into three groups of four partitions each, Group 1 306, Group 2 304, and Group 3 308. Note that the memory usage to process partitions 1-12 will be 3/2*2ⁱ, or 12 representative timestamps. Note that because the rate is dependent on the number of iterations, this rate of memory usage is independent of the number of partitions.

A scan may show that the amount of time taken to collect the messages of Group 2 304 of grouping 300 is less than that of the target rate r/m—e.g., since it is known that all groups represent r/2 messages, the cumulative times of the partitions that make up Group 2 304 (made up of partitions 5, 6, 7, and 8) is less than m. Because of the imposition of the target rate r/m, there must be a series of r/2 elements grouped uniformly with the range of Group 2 304 (e.g., within blocks 5, 6, 7, and 8), that falls under the time constraint imposed by the target rate of r/m. Thus, it may be assumed that blocks 5, 6, 7, and 8 as a group have potentially breached the threshold rate, and r/2 partitions of the 3r/2 partitions in the buffer may be discarded from further analysis, but the remaining prior and following blocks 1-4 and 9-12 of Group 1 306 and Group 3 308 must be analyzed to positively determine if the rate has been breached.

Note that in the prior scanning step, if a potential breach was not detected in a group of partitions 5, 6, 7, 8 making up Group 2 304, then a new focus group made up of partitions 6, 7, 8, 9 would be scanned, and the scanning would continue until a potential breach is detected. The remaining steps only occur in the case of a potential breach.

After Group 2 304 has been removed from the buffer, the remaining partitions 1-4 and 9-12 may be re-grouped into four groups, Group 1 312 made up of partitions 1 and 2, Group 2 314 made up of partitions 3 and 4, Group 3 316 made up of partitions 9 and 10, and Group 4 318 made up of partitions 11 and 12. Because it is known that Group 2 304 contained r/2 messages, and the time m′ taken for Group 2 304 is also known, after Group 2 304 is removed the new target rate 310 may be calculated as (r/2)/(m−m′). Thus, the number of timestamps in Groups 1-4 312-318 may be halved, and the time period m″ reduced from m to m-m′.

To determine if there is really a breach, Groups 1-4 must be analyzed to determine if the remaining r/2 messages were transmitted in less than m″ seconds. In order to analyze groups 1-4 as a prior, focus, and following group, Groups 1-4 are split into two branches, with the first branch including Group 1 320 corresponding to Group 1 312, Group 2 322 corresponding to Group 2 314, and Group 3 324 corresponding to Group 3 316, and the second branch including Group 2 326 corresponding to Group 2 314 (and Group 2 322), Group 3 328 corresponding to Group 3 316 (and Group 3 324), and Group 4 330 corresponding to Group 4 318. Note that because m″ corresponding to Target 332 may vary, although exemplary Target 332 is depicted as beginning in partition 3 and ending in partition 11, in various scenarios Target 332 may be shifted to include all or portions of partitions 1, 2, or 11; thus group 1 320 may not be dropped from the buffer even though it does not overlap Target 332.

Once the Groups have been divided into two branches of Groups 1-3 320-324 and Groups 2-4 326-330, the detection method described above may be re-run sequentially on each branch using a new target rate of (r/2)/m″ and groups of size r/4 with Group 2 322 the focus group, Group 1 320 the prior group, and Group 3 the following group of the first branch, and Group 3 328 the focus group, Group 2 326 the prior group, and Group 4 330 the following group of the second branch. Note that if the first branch on which the method is run produces a potential threshold breach, the next iteration may be run with the first branch sub-divided, and the other branch may be disregarded. Thus, in some scenarios the method may be even more efficient in detecting a breach.

In the exemplary grouping of FIG. 3, if a potential breach is detected in the second branch Group 3 328 based on the new target rate 332, as above with respect to Group 2 304, it may be assumed that because of the imposition of the target rate (r/2)/m″, there must be a series of r/4 elements grouped uniformly with the range of Group 3 328 (e.g., within blocks 9 and 10), that falls under the time constraint imposed by the adjusted target rate of (r/2)/m″. Thus, it may be assumed that blocks 9 and 10 as a group have potentially breached the threshold rate, and r/4 partitions of the 3r/4 partitions in the buffer may be discarded from further analysis, but the remaining prior and following blocks 3-4 and 11-12 of the remaining groups must be analyzed to positively determine if the rate has been breached. Note that Group 1 320 may also be discarded from the buffer because it was not part of the branch where a potential breach was detected.

In the final iteration of the evaluation of the partitions of grouping 300, each partition 3, 4, 11, and 12 of size r/8 may be evaluated as an indivisible group 334, 336, 338, 340 to determine if they breach an adjusted target rate 342. The target rate 342 may be calculated as described above for Target 310—because it is known that Group 3 328 contained r/4 messages and the time m′″ for Group 3 328 is also known, after Group 3 328 is removed the new target rate 342 may be calculated as (r/4)/(m″−m′″); thus, the time period m″″ may be m−m′−m′″ or m″−m′″.

As above, partitions 3, 4, 11, and 12 may be analyzed as prior 3 344, focus 4 346, and following 11 348 elements of a first branch and prior 4 350, focus 11 352, and following 12 354 elements of a second branch. As depicted, partition 4 346 may be determined to take less time than m″, and partition 4 is indivisible, in which case a breach may positively be verified.

Note that although FIG. 3 depicts a scenario where a breach 346 may be detected, a potential breach may be detected in the first iteration at Group 2 304 but the analysis of the remaining candidates in the following iterations, Group 2 322, Group 3 328, partition 4 346, or partition 11 352 may not detect that the adjusted target rates 332 or 356 are breached, and in such cases the analysis will conclude without a positive detection and without continuing through the remaining iterations (if any at the time of the negative determination).

A miss may happen where a threshold breach occurred but went undetected, for example if a lull in messages occurs in the focus partition 346 or 352 in the last iteration but there were sufficient messages received in a burst during the time period encompassed by the prior partition 344 or following partition 354 that a threshold condition did occur. Note that it would be impossible to have a miss due to message clustering at the edge of following partition 11 348 or prior partition 4 350 because they would be evaluated in the other branch. For example, partition 4 may take a relatively long time even though it is only half the messages in the Target 356, but many of the messages represented by partition 3 may have arrived at the end of the time period represented by partition 3, causing a breach but remaining undetected.

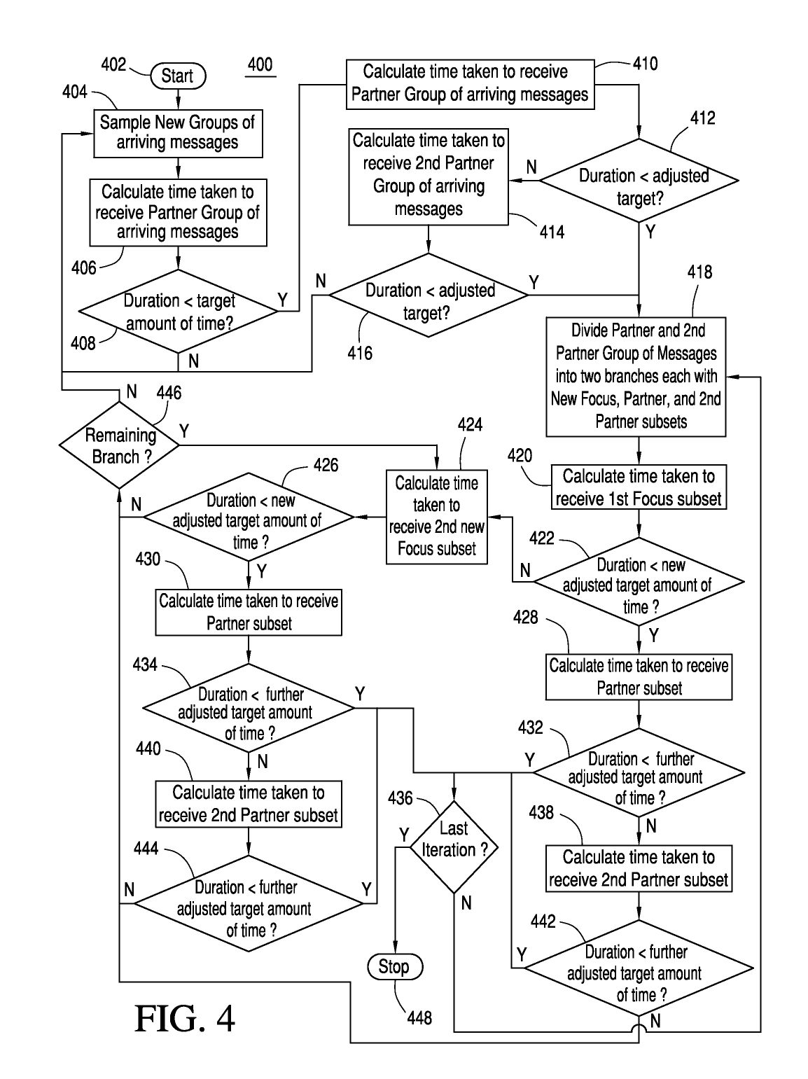

FIG. 4 illustrates an exemplary depiction of a method 400 for detecting a potential breach of a target rate limit. The method may start at step 402, and at step 404 incoming messages may be messages may be sampled, divided into partitions, and the partitions aggregated into groups of r/2 messages, including at least a focus group. Note that step 404 may continue in parallel with other steps, if, for example, not enough messages have been received to create a following group of r/2 messages as described above. At step 406 the time taken to receive the messages in the focus group may be calculated based on message timestamps. In step 408, if it is determined that the focus group messages do not exceed the target rate, no breach may be detected and the method may return to step 404 to sample a new focus group of arriving messages. In step 408, if the messages in the focus group exceed the target rate, then the method proceeds to step 410 where the time taken to receive the messages in a partner group, either a prior or following group, may be calculated based on message timestamps. In step 412, if it is determined that the messages in the partner group do not exceed the adjusted target rate (m′ as discussed above), the method continues to step 414 where the time taken to receive the messages in the remaining partner group may be calculated based on message timestamps. In step 416, if it is determined that the messages in the remaining partner group do not exceed the adjusted target rate (m′), then no breach is detected and the method returns to step 404 to sample a new focus group of arriving messages.

If in either step 412 or step 416 it is determined that the partner group or second partner group, respectively, exceed the adjusted target rate, the method continues to step 418, where the partitions in the original focus group are discarded and the prior and following partner groups are divided into two branches, each with new focus, partner, and 2^{nd} partner subsets as discussed above with respect to FIGS. 2 and 3. As discussed above with respect to steps 2 through 4 of FIG. 2, steps 418 through 448 may iteratively apply steps 404 through 416 to the partitions in the partner groups in a recursive manner, so that in an ideal case only a portion of the buffer may be scanned in any iteration.

Thus in step 420, similar to step 406, the time taken to receive the messages in the focus subset of the first branch may be calculated based on message timestamps. In step 422, if it is determined that the first branch's focus subset messages do not exceed the new adjusted target rate (based on m″, calculated as discussed above), the method may continue to the second branch at step 424 to calculate the time taken to receive the messages in the focus subset of the second branch based on message timestamps. In step 426, if it is determined that the second branch's focus subset messages do not exceed the new adjusted target rate, the method may continue to step 446 to determine if there are any remaining branches up the tree with uncalculated second-branch focus subsets. If no branches remain, no breach may be detected and the method may return to step 404 to sample a new focus group of arriving messages. If there are remaining branches, the method may return to step 424 for the next closest branch up the tree with uncalculated second-branch focus subsets.

The branches for the first and second focus subset branches proceed similarly if it is determined that the branch's focus subset exceeds the new adjusted target rate, and steps 428-434 and 338-444 are similar to steps 410-416. In steps 422 and 426, if it is determined that the messages of either the first focus subset or second focus subset, respectively, exceed the new adjusted target rate, the method continues to steps 428 or 430, respectively. In steps 428 and 430, the time taken to receive the messages in a partner subset, either a prior or following subset of the current branch, may be calculated based on message timestamps. In steps 432 and 434, if it is determined that the messages in the partner subset do not exceed the further adjusted target rate (m″″ as discussed above), the method continues to steps 438 or 440 for each branch, respectively, where the time taken to receive the messages in the remaining partner subset may be calculated based on message timestamps.

In steps 442 and 444, if it is determined that the messages in the remaining partner subset for the branch do not exceed the further adjusted target rate (m″″), then no breach is detected for the branch and the method continues to step 446 to determine if there are any remaining branches up the tree with uncalculated second-branch focus subsets. If in either steps 432, 442, 434, or 444 it is determined that the partner group or second partner group, respectively, for the branch exceeds the further adjusted target rate, the method continues to step 436 to determine if this is the last iteration of the method. If it is not the last iteration, the method returns to step 418 to further branch by further sub-dividing the prior and following subsets into prior, focus, and following subsets as discussed with respect to FIGS. 2 and 3. If in step 436 it is determined that it is the last iteration, then a breach is detected and the method stops at step 448.

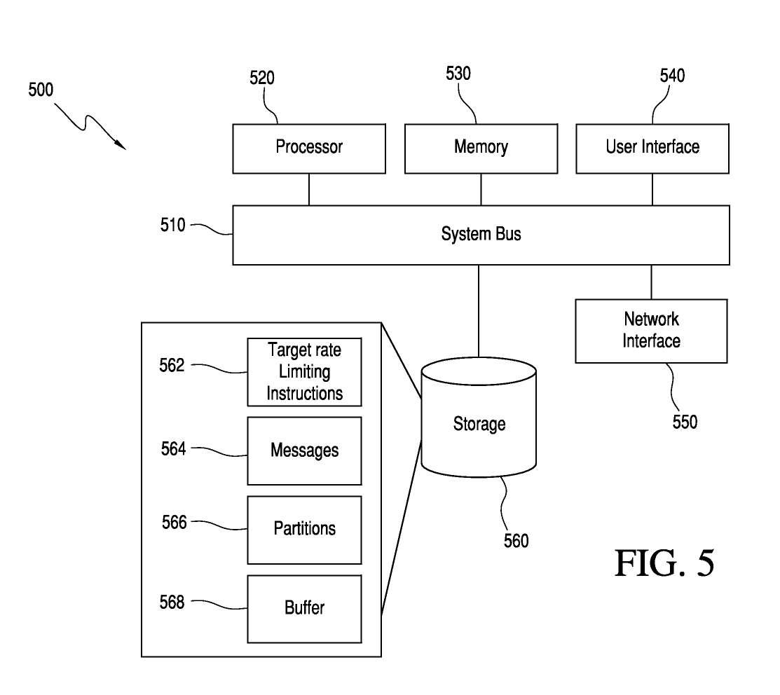

FIG. 5 illustrates an exemplary hardware diagram for a device 500 in which communications traffic may be rate limited, such as, for example, a network node, client, or server. As shown, the device 500 includes a processor 520, memory 530, user interface 540, network interface 550, and storage 560 interconnected via one or more system buses 510. It will be understood that FIG. 5 constitutes, in some respects, an abstraction and that the actual organization of the components of the device 500 may be more complex than illustrated.

The processor 520 may be any hardware device capable of executing instructions stored in memory 530 or storage 560. As such, the processor may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random access memory (SRAM), dynamic RAM (DRAM), flash memory, read only memory (ROM), or other similar memory devices.

The user interface 540 may include one or more devices for enabling communication with a user such as an administrator. For example, the user interface 540 may include a display, a mouse, and a keyboard for receiving user commands.

The network interface 550 may include one or more devices for enabling communication with other hardware devices. For example, the network interface 550 may include a network interface card (NIC) configured to communicate according to the Ethernet protocol. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon with the processor 520 may operate. For example, the storage 560 may store Target Rate Limiting instructions 562 for determining if a target rate has been breached according to the concepts described herein. The storage may also store Messages 564, Partitions 566, and a Buffer 568 for use by the processor executing the Target Rate Limiting instructions 562.

According to the foregoing, various exemplary embodiments provide for detecting potential overload situations in a communications device. In particular, by efficiently detecting when messages are arriving at a rate higher than a threshold.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for detecting that messages are incoming to a networked device above a target rate, the method comprising:
recording a timestamp for at least three representative samples of messages arriving at the networked device;
calculating the duration of a focus group comprising one or more of the representative samples, wherein the target rate is a number r messages over a number m seconds and the focus group represents r/2 messages; and
determining the duration of the focus group is less than m seconds.

2. The method of claim 1 wherein each representative sample of messages is the same size.

3. The method of claim 1, further comprising:
determining the target rate;
determining an accuracy; and
calculating a number of iterations i based on the accuracy.

4. The method of claim 3, further comprising calculating a partition size based on the accuracy and the target rate; and
wherein a size of each of the representative sample of messages is the partition size.

5. The method of claim 4 wherein the partition size represents 1 message for every r/2ⁱ messages received by the device.

6. The method of claim 3 wherein the accuracy is 1−(0.05)ⁱ wherein i is the number of iterations.

7. The method of claim 3, further comprising determining a buffer size, wherein the buffer size is 3/2*2ⁱ multiplied by the size of a timestamp in memory.

8. The method of claim 3, further comprising:
calculating the duration of a prior group comprising one or more of the representative samples, wherein the prior group represents r/2 messages received by the device immediately prior to the focus group; and
determining the duration of the focus group and the prior group is less than m seconds.

9. The method of claim 8, further comprising:
determining an adjusted target rate of a number r/2 messages over a number m′ seconds where m′ is m seconds minus the duration of the focus group;
determining a following group comprising one or more of the representative samples, wherein the following group the represents r/2 messages received by the device immediately after the focus group; and
dividing the prior group and the following group into four groups, a first group, a second group, a third group, and a fourth group, wherein each of the first and second groups represents r/4 messages comprising the r/2 messages comprising the prior group and each of the third and fourth groups represents r/4 messages comprising the r/2 messages comprising the prior group.

10. The method of claim 9, further comprising:
creating a first branch comprising the first group, the second group, and the third group; and
creating a second branch comprising the second group, the third group, and the fourth group.

11. The method of claim 10, further comprising:
creating a first branch comprising the first group, the second group, and the third group; and
creating a second branch comprising the second group, the third group, and the fourth group.

12. The method of claim 11, further comprising:
determining the duration of the second group is less than m′;
determining the duration of the first group; and
determining the duration of the third group.

13. The method of claim 3, further comprising:
calculating the duration of a following group comprising one or more of the representative samples, wherein the following group represents r/2 messages received by the device immediately after the focus group; and
determining the duration of the focus group and the following group is less than m seconds.

14. The method of claim 13, further comprising determining if there are not enough representative samples to create a following group representing r/2 messages, delaying the step of determining the duration of the focus group and the following group until enough representative samples have been collected to create a following group representing r/2 messages.

15. The method of claim 3, further comprising determining if the focus group comprises more than one representative sample.

16. A method for detecting that messages are incoming to a networked device above a target rate, the method comprising:
determining the target rate of a number r messages over a number m seconds;
determining an accuracy;
calculating a number of iterations i based on the accuracy;
recording a timestamp for at least three representative samples of messages arriving at the networked device;
calculating the duration of a focus group comprising one or more of the representative samples, wherein the focus group represents r/2 messages; and
determining the duration of the focus group is less than m seconds;
calculating the duration of a prior group comprising one or more of the representative samples, wherein the prior group represents r/2 messages received by the device immediately prior to the focus group;
calculating the duration of a following group comprising one or more of the representative samples, wherein the following group the represents r/2 messages received by the device immediately after the focus group;
determining the duration of the focus group and at least one of the prior group and the following group is less than m;
determining an adjusted target rate of the number of messages in the focus group over a number of seconds m′, wherein m′ is m minus the duration of the focus group;
dividing the prior group and the following group into four groups, a first group, a second group, a third group, and a fourth group, wherein each of the first and second groups represents r/4 messages comprising the r/2 messages comprising the prior group and each of the third and fourth groups represents r/4 messages comprising the r/2 messages comprising the prior group;
creating a first branch comprising the first group, the second group, and the third group; and
creating a second branch comprising the second group, the third group, and the fourth group.

17. The method of claim 16, further comprising:
determining if the focus group comprises more than one representative sample; and
until the focus group does not comprise more than one representative sample, or determining the duration of the focus group and each of the prior group and the following group is greater than or equal to the adjusted rate, repeating the steps of:
calculating the duration of a focus group,
determining the duration of the focus group,
calculating the duration of a prior group,
calculating the duration of a following group,
determining the duration of the focus group and at least one of the prior group and the following group,
determining an adjusted target rate,
dividing the prior group and the following group into four groups,
creating a first branch, and
creating a second branch.

18. A networked device, the device comprising:
a network interface; and
a processor in communication with the network interface, the processor being configured to:
receive, via the network interface, messages;
record a timestamp for at least three representative samples of messages;
calculate the duration of a focus group comprising one or more of the representative samples, wherein a target rate is a number r messages over a number m seconds and the focus group represents r/2 messages; and
determine the duration of the focus group is less than m seconds.

19. The device of claim 18, wherein the processor is further configured to:
determine the target rate;
determine an accuracy;
calculate a number of iterations i based on the accuracy;
calculate a partition size based on the accuracy and the target rate, wherein a size each of the representative sample of messages is the partition size, wherein the partition size represents 1 message for every r/2ⁱ messages received by the device;
calculate the duration of a prior group comprising one or more of the representative samples, wherein the prior group represents r/2 messages received by the device immediately prior to the focus group; and
determine the duration of the focus group and the prior group is less than m seconds.

20. A non-transitory machine-readable storage medium encoded with instructions for execution by a networked device for detecting that messages are incoming to the networked device above a target rate, the non-transitory machine-readable storage medium comprising:
instructions for recording a timestamp for at least three representative samples of messages arriving at the networked device;
instructions for calculating the duration of a focus group comprising one or more of the representative samples, wherein the target rate is a number r messages over a number m seconds and the focus group represents r/2 messages; and
instructions for determining the duration of the focus group is less than m seconds.
